(19) United States
(12) Patent Application Publication
(10) Pub. No.: US 2009/0079157 A1
(43) Pub. Date: Mar. 26, 2009

(54) VEHICLE MOUNTED STEP

(76) Inventor: Harold Fratzke, Cottonwood, MN (US)

Correspondence Address: SCHWEGMAN, LUNDBERG & WOESSNER, P.A., P.O. BOX 2938, MINNEAPOLIS, MN, 55402, US

(21) Appl. No.: 12/233,782

(22) Filed: Sep. 19, 2008

Related U.S. Application Data
(60) Provisional application No. 60/974,326, filed on Sep. 21, 2007.

(51) Int. Cl. B60R 3/00

(52) U.S. Cl. 280/166

(57) ABSTRACT

The present subject matter includes method and apparatus for a vehicle mounted step. Examples include a step apparatus comprising a frame having a first end and a second end, a first step member having a first end and a second end, a first pivot connection adapted to couple the first end of the first step member to the first end of the frame and a frame connecting member to couple the frame to the hitch receiver using a receiver pin, wherein the frame connecting member includes a drawbar and a hitch ball, wherein the frame includes a top portion connected to a bottom plate using a first and a second support member, the first and second support member sized to allow the frame connecting member to pass between the first and the second support members, wherein the frame includes a collar to secure the frame to the frame connecting member using a set screw and a jam nut, and wherein the first step member include a first step plate connected to a first tubular shaft. Other examples include methods for using a vehicle mounted step.

### RELATED APPLICATIONS

This application claims priority under 35 U.S.C 119(e) to U.S. Provisional Patent Application Ser. No. 60/974,326 filed Sep. 21, 2007 which is incorporated herein in its entirety.

### TECHNICAL FIELD

This document relates to vehicle accessories and more particularly to vehicle mounted steps.

### SUMMARY

This document provides apparatus and methods related to vehicle mounted steps that enhances vertical access to a vehicle or the area about the step. Various apparatus embodiments provide a frame, a first step member, a second step member, and a first and a second pin for securing the step members. According to various method embodiments, an apparatus with a first and second step member is attached to a hitch receiver, the first step member is positioned into a desired position and secured, and the second step member is positioned into a desired position and secured.

This Summary is an overview of some of the teachings of the present application and is not intended to be an exclusive or exhaustive treatment of the present subject matter. Further details about the present subject matter are found in the detailed description and the appended claims. The scope of the present invention is defined by the appended claims and their equivalents.

### BRIEF DESCRIPTION OF DRAWINGS

FIGS. 1A and 1B illustrate an embodiment of a vehicle mounted step assembly.

FIG. 2 illustrates an embodiment of a vehicle mounted step assembly attached to a hitch receiver of a vehicle.

FIGS. 3A and 3B illustrate an embodiment of a vehicle mounted step assembly with the step members positioned and secured such that the step plates are located away from the vehicle and adjacent to each other.

FIG. 4 illustrates an embodiment of a vehicle mounted step assembly connected to a vehicle with the step plates positioned away from the vehicle and adjacent each other.

FIGS. 5A, 5B, 5C and 5D illustrate connection options for an embodiment of a vehicle mounted step assembly.

FIG. 6 illustrates an embodiment of a method of using a vehicle mounted step assembly.

### DETAILED DESCRIPTION

The following detailed description of the present invention refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

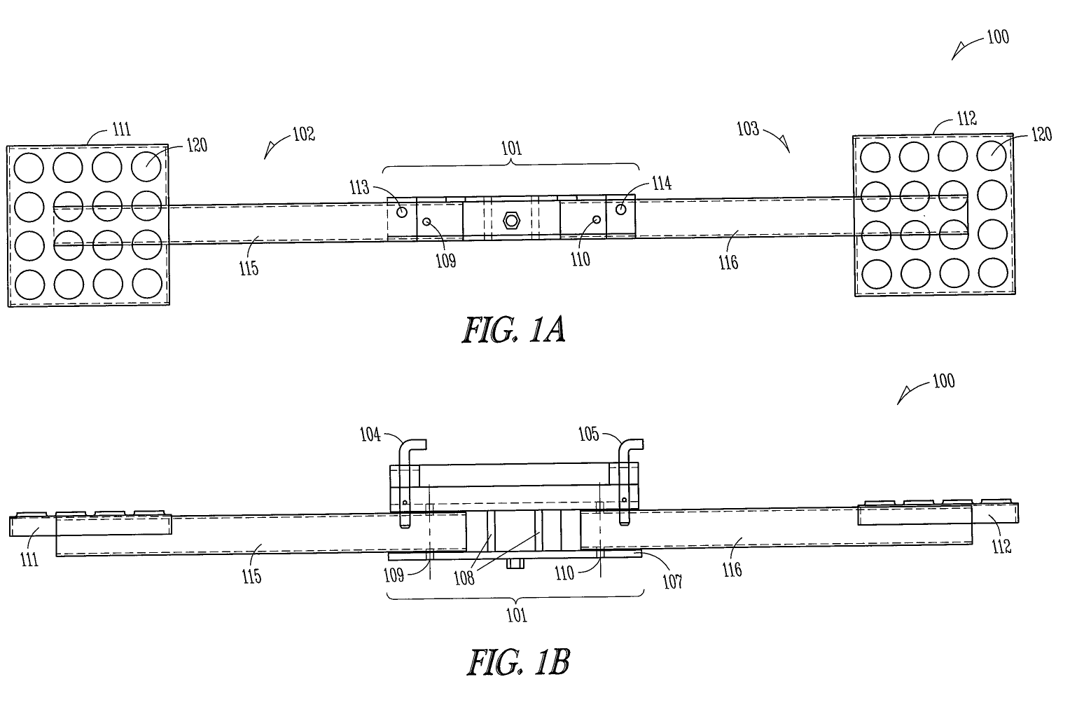

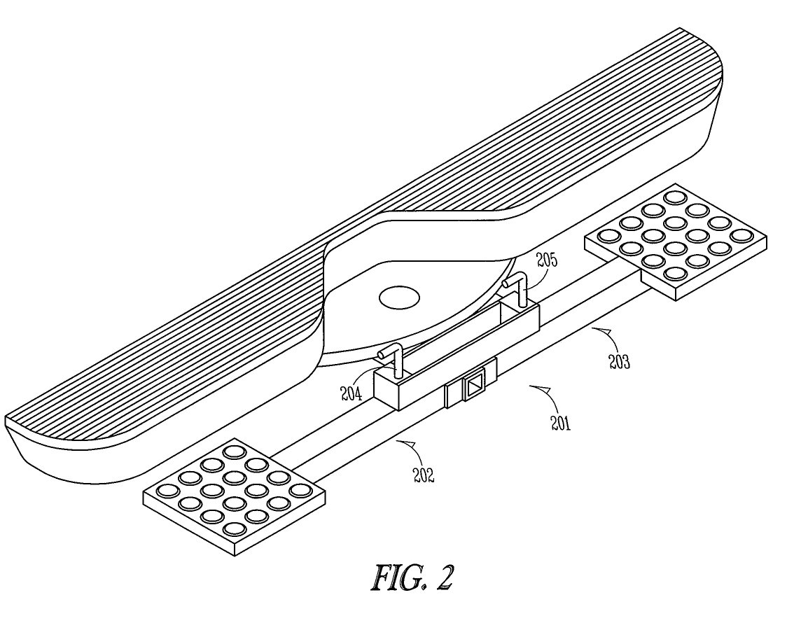

FIGS. 1A and 1B illustrate an embodiment of a vehicle mounted step assembly 100. FIGS. 1A and 1B show a frame 101, a first step member 102 and a second step member 103. FIG. 1B shows a first pin 104 and a second pin 105. The frame provides support for the assembly during operation and connects to a vehicle hitch receiver using, for example, a receiver insert or a drawbar. The first 102 and second 103 step members are pivotally connected to the frame between a top frame member 106 and a bottom frame plate 107. In the embodiment illustrated in FIG. 1B, the top frame member 106 is connected to the bottom frame plate 107 using support members 108. On each end of the first and second step member opposite their respective pivot connection 109, 110, a step plate is fastened 111, 112. In various embodiments, the step plate is formed as a single unit with the step member. The first and second pins are used to fix the position of the pivotally moveable step members. In the illustrated embodiment, the first and second pins are used to secure the step members using holes 113, 114 extending through the top frame member 106 and a hole extending through one side of each of the tubular shafts 115, 116 of the step members. In various embodiments, the pins 104, 105 are spring loaded. In various embodiments, the pins are connected to the frame 101 such that they remain retained in the frame 101 whether they are securing the step members or not.

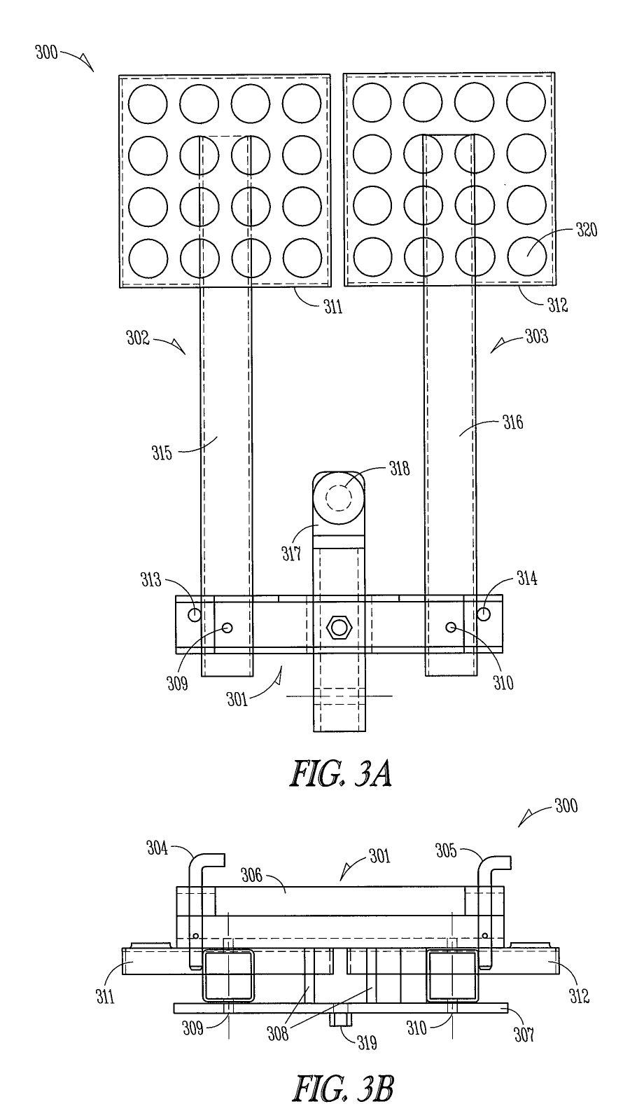

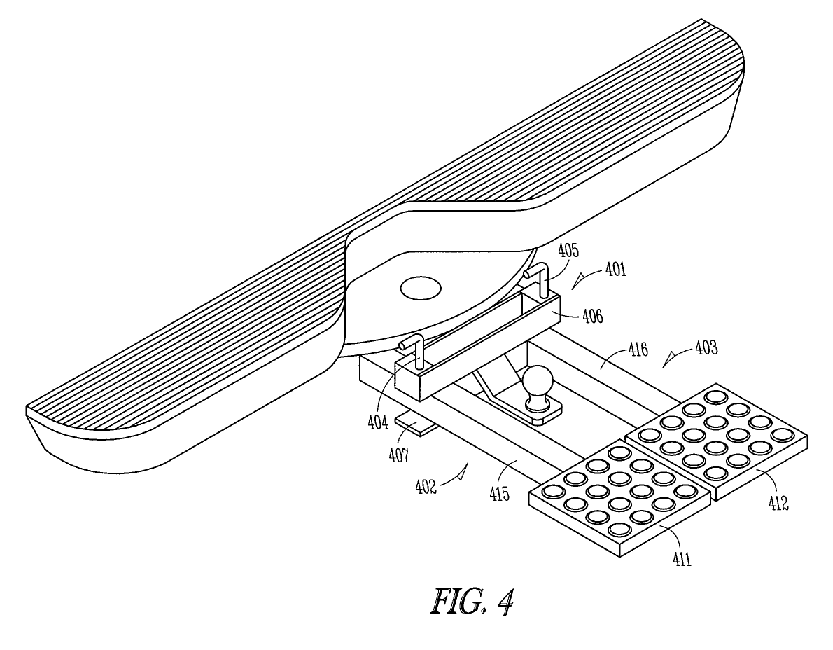

FIG. 2 illustrates an embodiment of a vehicle mounted step assembly attached to a hitch receiver of a vehicle. FIG. 2 shows the frame 201, a first step member 202, a first pin 204, a second step member 203 and a second pin 205. In various embodiments, the vehicle mounted step assembly 200 includes a draw bar and hitch ball to allow a trailer or other accessory to be attached to the vehicle. In FIG. 2 the step members of the vehicle mounted step assembly are orientated and secured in place by the pins such that the step plates are positioned apart from each other and both step plates are adjacent the vehicle. One or more users can use the step plates to provide higher, easier and safer vertical access to the vehicle, or areas adjacent the vehicle. The user or users can position either of the step plates, as shown in FIG. 2 and release, pivot and secure the other step member, using one of the pins, in a position such that the length of the step member is approximately perpendicular to the length of the other step member. In various embodiments, the surface of the step plates include voids 120, 320 as illustrated in the embodiment of FIGS. 1A and 3A. Water will not accumulate on the step plates, as it will fall through the voids to the ground. Also, the voids reduce the weight of the step plates. In various embodiments, the surface of the step plate does not include voids. In various embodiments, the surface of the step plates includes a textured component to provide traction for a user's foot or footwear. In various embodiments, the step assembly includes components made from metal, such as steel or aluminum for example. In various embodiments, metal components of the step assembly are coated to prevent corrosion.

FIGS. 3A and 3B illustrate an embodiment of a vehicle mounted step assembly 300 with the step members positioned and secured such that the step plates are located away from the vehicle and adjacent to each other. FIG. 3 shows the frame 301, including the top portion 306, the bottom plate 307 and the connecting members 308. FIGS. 3A and 3B also show the first step member 302 and the first pin 304 and the second step member 303 and the second pin 305. The first step member 302 includes a first step plate 311 connected to a first end of a first tubular shaft 315. The first step member 302 is connected to the frame 301 using a second of the first tubular shaft 315 at a first pivot connection 309. The second step member 303 includes a second step plate 312 connected to a first end of a second tubular shaft 316. The second step member 303 is connected to the frame 301 using a second end of the second tubular shaft 316 at a second pivot connection 310. In the illustrated embodiment of FIG. 3A and 3B, the first and second step members are secured in position using a first pin 304 and a second pin 305. The first and second pins extend through holes 313, 314 in the top portion of the frame 301 and interfere with one direction of rotational motion of each step member. The interference of the rotation motion occurs when the exterior portion of each step member tubular shaft contacts the pin. The positions of the step members are further secured as the frame 301 limits rotational motion in the opposite direction as the rotational motion limited by each pin. The embodiment of FIG. 3A also shows a draw bar 317 and a hitch ball 318 connected to the drawbar 317. The drawbar 317 extends through the frame 301 between the connecting members 308. Attaching the frame 301 to the drawbar 317 includes tightening a set screw against the drawbar using a threaded hole 319 in the bottom plate 307. In various embodiments, a jam nut is tightened against the frame to secure the set screw.

FIG. 4 illustrates an embodiment of a vehicle mounted step assembly connected to a vehicle with the step plates positioned away from the vehicle and adjacent each other. FIG. 4 shows a frame 401, including a top portion 406 and a bottom plate 407, a first step member 402 with a first step plate 411, a first pin 404 and a first tubular shaft 415, and a second step member 403 with a second step plate 412, second pin 405 and second tubular shaft 416. Positioning the step plates away from the vehicle and adjacent each other allows one or more users higher, easier and safer vertical access to the vehicle and/or areas surrounding the vehicle. In the illustrated embodiment of FIG.4, a user is able to step into the bed of the vehicle using the step assembly and the open tailgate of the vehicle's bed. In various embodiments, the step assembly includes a drawbar and a hitch ball connected to the drawbar to allow a trailer or other accessory to be connected to the vehicle.

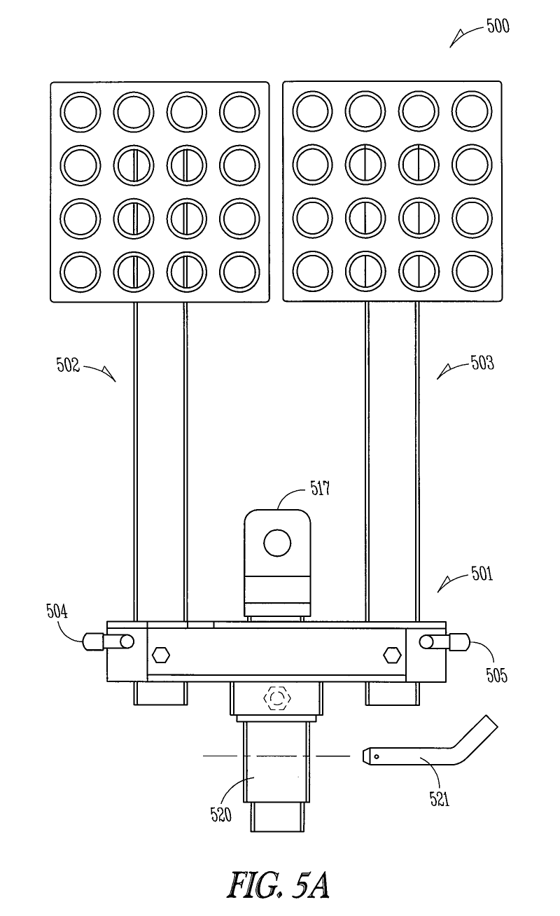

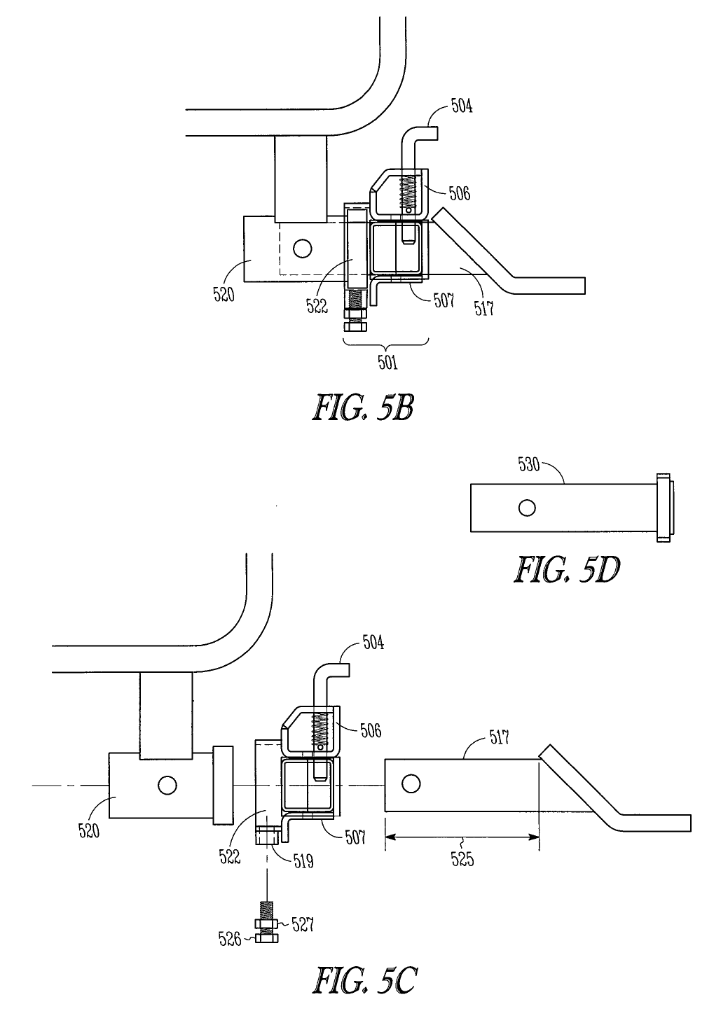

FIGS. 5A, 5B, 5C and 5D illustrate connection options for a vehicle mounted step assembly. FIG. 5A shows a step assembly 500 including a frame 501, a first step member 502, a second step member 503, a first pin 504, a second pin 505, a drawbar 517 and hitch receiver 520 and receiver pin 521. FIG. 5B illustrates a cutaway side view of a vehicle mounted step assembly 500. FIG. 5B shows a hitch receiver 520, a frame 501, a first pin 504 and a drawbar 517. The embodiments of FIGS. 5B and 5C show a frame 501 including a top portion 506, a bottom plate 507 and a mounting collar 522. The mounting collar 522 includes a threaded hole 519 for a set screw 526. In various embodiments, the frame 501 connects to the hitch receiver 520 using a receiver pin 521 and a receiver insert 523. In various embodiments, the frame 501 connects to the vehicle hitch receiver using a receiver pin 521 and a draw bar 517 with adequate room between the hitch pin clearance hole 523 and the ball mount weldment 524 as shown by dimension 525 to accommodate the frame 501. In various embodiments, a set screw 526 is tightened against a drawbar 517 or receiver insert 523 through a treaded hole 519 of a collar 522 to secure the frame to the vehicle. In various embodiments, a jam nut 527 is tighten against the collar 522 to secure the set screw 526.

FIG. 5C illustrates an exploded view of a connection of a step assembly 500 to a vehicle hitch receiver 520 using a drawbar 517 according to one embodiment of the present subject matter. FIG. 5C shows a vehicle hitch receiver 520, a vehicle mounted step assembly frame 501 including a top portion 506, a bottom plate 507 and a collar 522, a first pin 504 and a drawbar 517 indicating dimension 525 necessary extend the drawbar 517 through the frame 501 and connect the drawbar 517 to the vehicle hitch receiver 522 using a receiver pin. Also shown in the embodiment of FIG. 5C is a set screw 526 and jam nut 527 used to secure the frame 501 to the drawbar 517 using the threaded hole 519 of the frame's collar 522.

FIG. 5D illustrates a receiver insert 530 according to one embodiment of the present subject matter. The receiver insert 530 can be used to connect the step assembly frame to a vehicle hitch receiver.

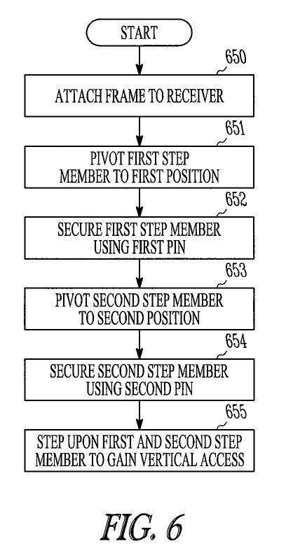

FIG. 6 illustrates an embodiment of a method of using a vehicle mounted step assembly. The frame of the apparatus is attached to a hitch receiver, as illustrated at 650. In various embodiments, securing the frame to a hitch receiver includes inserting a frame connecting member through the frame and into the hitch receiver. A drawbar or receiver insert are examples of frame connecting members. In various situations where a user requires both step plates of the apparatus to gain vertical access, as in the method embodiment of FIG. 6, the first step member is pivoted 651 to a first position and secured 652 using a first pin. The second step member is pivoted 653 to a second position and secured 654 using a second pin. The user is then able to step 655 upon the first and second step plats and gain increased vertical access to the surroundings.

This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. A step apparatus for mounting to a vehicle hitch receiver, the apparatus comprising:
a frame having a first end and a second end;
a first step member having a first end and a second end;
a first pivot connection adapted to couple the first end of the first step member to the first end of the frame; and
a frame connecting member to couple the frame to the hitch receiver using a receiver pin, wherein the frame connecting member includes a drawbar and a hitch ball;
wherein the frame includes a top portion connected to a bottom plate using a first and a second support member, the first and second support member sized to allow the frame connecting member to pass between the first and the second support members,
wherein the frame includes a collar to secure the frame to the frame connecting member using a set screw and a jam nut, and
wherein the first step member include a first step plate connected to a first tubular shaft.

2. The apparatus of claim 1, wherein the first pin is spring loaded.

3. The apparatus of claim 2, further comprising a first pin adapted to secure the first step member at one or more predetermined positions using the frame.

4. The apparatus of claim 1, further comprising a second step member having a first end and a second end, the second step member coupled to the frame.

5. The apparatus of claim 4, wherein the second step member includes a second step plate connected to a second tubular shaft.

6. The apparatus of claim 4, further comprising a second pivot connection adapted to couple the first end of the second step member to the second end of the frame.

7. The apparatus of claim 6, further comprising a second pin adapted to secure the second step member at one or more predetermined positions using the frame.

8. The apparatus of claim 7, wherein the second pin is spring loaded.

9. A method of using a vehicle mounted step assembly having a frame and a first step member and a second step member pivotally connected to the frame, the method including:
connecting the step assembly to a hitch receiver of a vehicle;
pivoting the first step member to a first position;
securing the first step member using a first pin;
pivoting the second step member to a second position; and
securing the second step member using a second pin.

10. The method of claim 9, wherein connecting the vehicle mounted step assembly to a hitch receiver includes:
inserting a first end of a frame connecting member through the frame, wherein the first end of the frame connecting member includes at least one first clearance hole;
inserting the first end of the frame connecting member into the hitch receiver;
aligning the at least one first clearance hole of the frame connecting member with at least one hitch receiver clearance hole;
inserting a receiver pin through the at least one first clearance hole of the frame connecting member and the at least one hitch receiver clearance hole;
tightening a set screw against the frame connecting member using a threaded hole in the frame;
tightening a jam nut threaded on the set screw against the frame to secure the set screw; and
attaching a hitch ball to the frame connecting member.

11. The method of claim 10, wherein:
pivoting the first step member to a first position includes:
releasing first step member using the first pin; and
rotating the first step member about the first pivot connection to the first position; and
pivoting the second step member to a second position includes:
releasing second step member using the second pin; and
rotating the second step member about the second pivot connection to the second position.
